(19) United States
(12) Patent Application Publication
(10) Pub. No.: US 2021/0316859 A1
(43) Pub. Date: Oct. 14, 2021

(54) UNMANNED AERIAL VEHICLES

(71) Applicant: SZ DJI TECHNOLOGY CO., LTD., Shenzhen (CN)

(72) Inventor: Li QIU, Shenzhen (CN)

(73) Assignee: SZ DJI TECHNOLOGY CO., LTD., Shenzhen (CN)

(21) Appl. No.: 17/111,524

(22) Filed: Dec. 4, 2020

Related U.S. Application Data
(63) Continuation of application No. PCT/CN2019/087763, filed on May 21, 2019.

(51) Int. Cl. B64C 39/02; B64D 27/24; B64C 1/36; H01Q 1/28

(52) U.S. Cl. CPC B64C 39/024; B64D 27/24; B64C 1/36; B64C 2201/108; B64C 2201/027; B64C 2201/042; H01Q 1/28

(57) ABSTRACT

This disclosure provides an unmanned aerial vehicle, including a central body; a plurality of arms, connected to the central body; a plurality of motor mounting bases, respectively disposed at ends of the plurality of arms away from the central body; a plurality of motors, respectively mounted on the plurality of motor mounting bases; a plurality of propellers, respectively connected to the plurality of motors, wherein the plurality of motors is configured to drive the propellers to rotate; and a plurality of antennas, respectively disposed on the plurality of motor mounting bases, wherein the plurality of propellers is located lower than the plurality of antennas. The unmanned aerial vehicle provided by this disclosure may ensure open space for mounting the antennas, featuring longer flight duration, fewer folding steps, and a higher storage speed.

### RELATED APPLICATIONS

The present patent document is a continuation application of PCT Application Serial No. PCT/CN2019/087763, filed on May 21, 2019, designating the United States and published in Chinese, content of which is herein incorporated by reference in its entirety.

### BACKGROUND

### 1. Technical Field

This disclosure relates to remotely controlled unmanned devices, and specifically, to unmanned aerial vehicles.

### 2. Background Information

Structures such as antennas need to be configured on an unmanned aerial vehicle to implement related functions. For example, a communication antenna and a positioning antenna are configured for communication with a remote-control apparatus and determination of a current location of the unmanned aerial vehicle, respectively. Based on experience, it is found that, to work reliably, the antennas basically need to be disposed in outermost positions on the unmanned aerial vehicle. In an existing unmanned aerial vehicle, a propeller and a motor providing power for the propeller are connected to a central body via a motor mounting base and an arm, and an antenna is arranged at a bottom of the motor. However, during flight, the antenna may be blocked, and its normal operation may be affected. Although an antenna support may be additionally configured to resolve the problem caused by a blocked antenna, this solution may cause the unmanned aerial vehicle result to have a relatively large structural weight, and a higher structural weight ratio, which directly affects a flight duration of the unmanned aerial vehicle, increases the number of steps needed for folding the unmanned aerial vehicle, and cause inconvenience for storage.

### BRIEF SUMMARY

The present disclosure provides unmanned aerial vehicles that make the antenna less blocked by the propeller by disposing the antenna higher than the propeller.

An aspect of this disclosure provides an unmanned aerial vehicle.

Another aspect of this disclosure provides another unmanned aerial vehicle.

In view of this, according to an aspect of this disclosure, an unmanned aerial vehicle may be provided and may include a central body, a plurality of arms, a plurality of motors, a plurality of propellers, and a plurality of antennas. The plurality of arms may be connected to the central body. A motor mounting base may be disposed at an end of each arm away from the central body, and the motor mounting base may include a top and a bottom that is opposite to the top. The plurality of motors may be mounted on the motor mounting bases of the plurality of arms, respectively. The plurality of propellers may be connected to the plurality of motors, respectively, and the motors may be configured to drive the propellers to rotate, to provide power for the unmanned aerial vehicle for flying. The plurality of antennas may be disposed on the motor mounting bases of at least two arms in the plurality of arms, respectively, and the antenna may be located on the top of the motor mounting base, where the propeller may be located in a position below the motor mounting base, and the antenna may be located in a position above the motor mounting base.

In the unmanned aerial vehicle provided by exemplary embodiments of this disclosure, the motor mounting base may be disposed at an end of the arm away from the central body. The motor mounting base, on one hand, may be configured to mount the motor for driving the propeller, and on the other hand, may provide a stable mounting position for the antenna. For example, the antenna may be mounted on the top of the motor mounting base and may be located in a position above the motor mounting base, and the propeller may be located in a position below the motor mounting base. This may ensure open space for mounting the antenna without adding an additional structure, make the antenna less blocked by a structure such as a propeller, and reduce the weight of the unmanned aerial vehicle, so that the unmanned aerial vehicle has longer flight duration, fewer folding steps, and a higher storage speed. For example, the motor may be mounted on the motor mounting base, and its specific mounting position may be not limited. For example, the motor may be located at an end of the motor mounting base that is farthest away from the central body. The propeller may be connected to the motor, as long as it is ensured that the propeller is located in a position below the motor mounting base.

In addition, the unmanned aerial vehicle in the exemplary embodiments provided by this disclosure may further have the following additional technical features.

In some exemplary embodiments, the antenna may include at least one of the following: a communication antenna, a positioning antenna, and a ranging antenna.

In some exemplary embodiments, the antenna may include at least one of a communication antenna, a positioning antenna, and a ranging antenna. The communication antenna may be configured to exchange data with the outside, the positioning antenna may be configured to obtain location information of the unmanned aerial vehicle, and the ranging antenna may be configured to detect a distance between the unmanned aerial vehicle and a nearby obstacle. Making the antenna less blocked may ensure normal operation of the antenna and facilitate reliable flight of the unmanned aerial vehicle.

In some exemplary embodiments, the antenna may include a communication antenna.

In some exemplary embodiments, the antenna may include a communication antenna for exchanging data with the outside. Because the communication antenna is located in a position above the motor mounting base, normal operation of the communication antenna may be ensured, and product reliability may be improved. In addition, an arrangement requirement of the communication antenna of the unmanned aerial vehicle may be satisfied without adding an additional structure. Therefore, the communication antenna may be arranged in a highly integrated manner, a fuselage weight may also be reduced to prolong the flight duration of the unmanned aerial vehicle, the unmanned aerial vehicle has fewer folding steps, and a higher storage speed.

In some exemplary embodiments, the plurality of arms may include a front arm, and the communication antenna may be disposed on a motor mounting base of the front arm.

In some exemplary embodiments, an arrangement position of the communication antenna may need to ensure the integrity of a directivity diagram of the communication antenna, that is, no other blocking structure should exist within coverage of the directivity diagram. Because the communication antenna is disposed on the motor mounting base of the front arm, integrity of the directivity diagram of the communication antenna may be ensured, and smooth communication may be maintained.

In some exemplary embodiments, there may be a plurality of communication antennas, and the plurality of communication antennas may be located on two sides of a roll axis of the unmanned aerial vehicle, respectively.

In some exemplary embodiments, there may be a plurality of communication antennas, and this may help improve communication capability of the unmanned aerial vehicle. The roll axis may be an axis of rotation when the unmanned aerial vehicle rolls left and right (that is, an axis that extends along front and rear directions of the unmanned aerial vehicle). The plurality of communication antennas may be located on the two sides of the roll axis of the unmanned aerial vehicle, respectively. This may ensure basically equal strength of communication signals in left and right directions of the unmanned aerial vehicle and ensure normal communication of the unmanned aerial vehicle.

In some exemplary embodiments, the plurality of communication antennas may be symmetrically disposed relative to the roll axis of the unmanned aerial vehicle.

In some exemplary embodiments, the plurality of communication antennas may be further defined as being symmetrically disposed relative to the roll axis of the unmanned aerial vehicle. This may not only enhance equal strength of communication signals in the left and right directions of the unmanned aerial vehicle, but also enable even weight distribution of the unmanned aerial vehicle and help ensure flight attitude balance of the unmanned aerial vehicle.

In some exemplary embodiments, the plurality of arms may include a front arm and a rear arm that is opposite to the front arm, a part of the communication antennas may be disposed on a motor mounting base of the front arm, and another part of the communication antennas may be disposed on a motor mounting base of the rear arm.

In some exemplary embodiments, disposing all the communication antennas separately on the front arm and the rear arm may expand signal coverage of the communication antennas, ensure that complete directivity diagrams may be obtained in both front and rear directions of the communication antennas, and help enhance communication reliability of the unmanned aerial vehicle.

In some exemplary embodiments, there may be a plurality of communication antennas, and the plurality of communication antennas may be located on two sides of a pitch axis of the unmanned aerial vehicle, respectively.

In some exemplary embodiments, there may be a plurality of communication antennas, and this may help improve communication capability of the unmanned aerial vehicle. The pitch axis may be an axis of rotation when the unmanned aerial vehicle raises or lowers its head (that is, an axis that extends along left and right directions of the unmanned aerial vehicle). The plurality of communication antennas may be located on the two sides of the pitch axis of the unmanned aerial vehicle, respectively. This may ensure basically equal strength of communication signals in front and rear directions of the unmanned aerial vehicle and ensure normal communication of the unmanned aerial vehicle.

In some exemplary embodiments, the plurality of communication antennas may be symmetrically disposed relative to the pitch axis of the unmanned aerial vehicle.

In some exemplary embodiments, the plurality of communication antennas may be further defined as being symmetrically disposed relative to the pitch axis of the unmanned aerial vehicle. This may not only enhance equal strength of communication signals in the front and rear directions of the unmanned aerial vehicle, but also enable even weight distribution of the unmanned aerial vehicle and help ensure flight attitude balance of the unmanned aerial vehicle.

In some exemplary embodiments, there may be a plurality of communication antennas, and the plurality of communication antennas may be at a same level relative to the central body.

In some exemplary embodiments, there may be a plurality of communication antennas, and this may help improve communication capability of the unmanned aerial vehicle. Because the plurality of communication antennas is at the same level relative to the central body, a structure of the unmanned aerial vehicle may be more compact, and this may help reduce the possibility of the communication antennas being damaged by an external force.

In some exemplary embodiments, there may be a plurality of communication antennas, and the plurality of communication antennas may be symmetrically disposed relative to the central body.

In some exemplary embodiments, there may be a plurality of communication antennas, and this may help improve communication capability of the unmanned aerial vehicle. The plurality of communication antennas may be symmetrically disposed relative to the central body. This may not only enhance equal strength of communication signals of the unmanned aerial vehicle in a circumferential direction of the central body, but also enable even weight distribution of the unmanned aerial vehicle and help ensure flight attitude balance of the unmanned aerial vehicle.

In some exemplary embodiments, the unmanned aerial vehicle may further include a conducting wire electrically connected to the communication antenna, the arm may be a hollow-tubular structure, and the conducting wire may be electrically connected to a control circuit of the central body via the arm after the conducting wire passes through the motor mounting base.

In some exemplary embodiments, the communication antenna is electrically connected to the control circuit of the central body by the conducting wire. This may ensure stability and reliability of data exchange between the communication antenna and the control circuit during the flight. The conducting wire may pass through the motor mounting base and the hollow-tubular arm and extend to the control circuit of the central body, so that the motor mounting base, the arm, and the central body may wrap the conducting wire. This, on one hand, may further improve protection for the conducting wire, and on the other hand, may make an exterior of the unmanned aerial vehicle simple.

In some exemplary embodiments, the communication antenna may be a line-of-sight communication antenna.

In some exemplary embodiments, the communication antenna may be a line-of-sight communication antenna. A radio signal may need to be propagated in a straight line between a transmitting end and a receiving end without being blocked, and a radio frequency thereof may be between 10 GHz and 66 GHz. Because the line-of-sight communication antenna is disposed in open space above the motor mounting base, signal blocking may be reduced for the communication antenna, and normal operation of the communication antenna may be ensured.

In some exemplary embodiments, the communication antenna may be a Wi-Fi (Wireless Fidelity, wireless local area network) antenna.

In some exemplary embodiments, the communication antenna may be further defined as a Wi-Fi antenna. This may enhance signal strength of the wireless network and improve the reliability of communication.

In some exemplary embodiments, the communication antenna may be configured to receive a control signal sent by a ground control terminal, and send, to the ground control terminal, sensing data of a sensor carried by the unmanned aerial vehicle.

In some exemplary embodiments, the communication antenna may be configured to exchange data with the ground control terminal. On one hand, the communication antenna may receive the control signal to control operation of the unmanned aerial vehicle based on the control signal. On the other hand, the communication antenna may send the sensing data of the sensor. When the sensing data is an operation parameter of the unmanned aerial vehicle, the ground control terminal may conveniently know an operation status of the unmanned aerial vehicle in time, and further perform a corresponding control operation. This may ensure reliable control by the ground control terminal over the unmanned aerial vehicle and improve safety of operation.

In some exemplary embodiments, the sensor may be an image sensor, and the sensing data may be image information.

In some exemplary embodiments, the sensor may be an image sensor, and the sensing data may be image information. In other words, a user may configure an image sensor on the unmanned aerial vehicle, and collect specific image information by virtue of a flight capability of the unmanned aerial vehicle, and the image information may be transmitted back to the ground control terminal via the communication antenna. Therefore, an image collection range may be expanded.

In some exemplary embodiments, the communication antenna may be disposed obliquely to or in parallel with a yaw axis of the unmanned aerial vehicle.

In some exemplary embodiments, the yaw axis may be an axis of rotation when the unmanned aerial vehicle adjusts a course (that is, an axis that extends along up and down directions of the unmanned aerial vehicle). Disposing the communication antenna obliquely to or in parallel with the yaw axis may ensure that the communication antenna has a trend of extending to an upper open space, and this may help ensure integrity of a directivity diagram of the communication antenna.

In some exemplary embodiments, the communication antenna may be disposed vertically to the top of the motor mounting base.

In some exemplary embodiments, the communication antenna may be defined as being disposed vertically to the top of the motor mounting base. This may ensure equal strength of communication of the communication antenna in a circumferential direction of the motor mounting base.

In some exemplary embodiments, the communication antenna may be disposed obliquely to the top of the motor mounting base.

In some exemplary embodiments, the communication antenna may be defined as being disposed obliquely to the top of the motor mounting base. The communication antenna may be disposed away from other structures of the unmanned aerial vehicle based on a requirement, so that the communication antenna may be less blocked.

In some exemplary embodiments, the antenna may include a positioning antenna.

In some exemplary embodiments, the antenna may include a positioning antenna for obtaining location information of the unmanned aerial vehicle. Because the positioning antenna is located in a position above the motor mounting base, normal operation of the positioning antenna may be ensured, and product reliability may be improved. In addition, an arrangement requirement of the positioning antenna of the unmanned aerial vehicle may be satisfied without adding an additional structure. Therefore, the positioning antenna may be arranged in a highly integrated manner, and a fuselage weight may be also reduced, so that flight duration of the unmanned aerial vehicle may be longer and that the unmanned aerial vehicle has fewer folding steps and a higher storage speed.

In some exemplary embodiments, the plurality of arms may include a front arm, and the positioning antenna may be disposed on a motor mounting base of the front arm.

In some exemplary embodiments, arranging the positioning antenna on the motor mounting base of the front arm may make the positioning antenna less blocked by a front structure and ensure accurate positioning.

In some exemplary embodiments, there may be a plurality of positioning antennas, and the plurality of positioning antennas may be located on two sides of a roll axis of the unmanned aerial vehicle, respectively.

In some exemplary embodiments, there may be a plurality of positioning antennas, and the plurality of positioning antennas may be located on the two sides of the roll axis of the unmanned aerial vehicle, respectively. This may increase spacings between the plurality of positioning antennas, increase radiation angles of the positioning antennas in a horizontal plane, and help improve positioning accuracy of the unmanned aerial vehicle.

In some exemplary embodiments, the plurality of positioning antennas may be symmetrically disposed relative to the roll axis of the unmanned aerial vehicle.

In some exemplary embodiments, the plurality of positioning antennas may be further defined as being symmetrically disposed relative to the roll axis of the unmanned aerial vehicle. This may not only enhance positioning accuracy of the unmanned aerial vehicle, but also enable even weight distribution of the unmanned aerial vehicle and help ensure flight attitude balance of the unmanned aerial vehicle.

In some exemplary embodiments, the plurality of arms may include a front arm and a rear arm that may be opposite to the front arm, a part of the positioning antennas may be disposed on a motor mounting base of the front arm, and another part of the positioning antennas may be disposed on a motor mounting base of the rear arm.

In some exemplary embodiments, disposing all the positioning antennas separately on the front arm and the rear arm may make the positioning antennas less blocked by nearby front and rear structures and ensure accurate positioning.

In some exemplary embodiments, there may be a plurality of positioning antennas, and the plurality of positioning antennas may be located on two sides of a pitch axis of the unmanned aerial vehicle, respectively.

In some exemplary embodiments, there may be a plurality of positioning antennas, and the plurality of positioning antennas may be located on the two sides of the pitch axis of the unmanned aerial vehicle, respectively. This may increase spacings between the plurality of positioning antennas, increase radiation angles of the positioning antennas in a horizontal plane, and help improve positioning accuracy of the unmanned aerial vehicle.

In some exemplary embodiments, the plurality of positioning antennas may be symmetrically disposed relative to the pitch axis of the unmanned aerial vehicle.

In some exemplary embodiments, the plurality of positioning antennas may be further defined as being symmetrically disposed relative to the pitch axis of the unmanned aerial vehicle. This may not only enhance positioning accuracy of the unmanned aerial vehicle, but also enable even weight distribution of the unmanned aerial vehicle and help ensure flight attitude balance of the unmanned aerial vehicle.

In some exemplary embodiments, there may be a plurality of positioning antennas, and the plurality of positioning antennas may be at a same level relative to the central body.

In some exemplary embodiments, there may be a plurality of communication antennas, and this may help enhance positioning accuracy of the unmanned aerial vehicle. Because the plurality of positioning antennas is at the same level relative to the central body, a structure of the unmanned aerial vehicle may be more compact, and this may help reduce the possibility of the positioning antennas being damaged by an external force.

In some exemplary embodiments, there may be a plurality of positioning antennas, and the plurality of positioning antennas may be symmetrically disposed relative to the central body.

In some exemplary embodiments, there may be a plurality of communication antennas, and the plurality of communication antennas may be symmetrically disposed relative to the central body. This may not only help enhance positioning accuracy of the unmanned aerial vehicle, but also enable even weight distribution of the unmanned aerial vehicle and help ensure flight attitude balance of the unmanned aerial vehicle.

In some exemplary embodiments, the positioning antenna may be a real-time differential positioning antenna.

In some exemplary embodiments, the positioning antenna may be defined as a real-time differential positioning antenna (for example, Real-time Kinematic (RTK) antenna). Centimeter-level positioning accuracy may be obtained outdoors in real time. This may satisfy a high-accuracy positioning requirement and expand an application scope of the unmanned aerial vehicle.

In some exemplary embodiments, the positioning antenna may be configured to receive a positioning signal from a satellite.

In some exemplary embodiments, the positioning antenna not directly used for positioning, but used for receiving a positioning signal from a satellite may be defined. This may reduce the amount of calculation and consumption of calculation time and help prolong flight duration.

In some exemplary embodiments, there may be two positioning antennas, and a spacing between the two positioning antennas may be greater than 30 cm.

In some exemplary embodiments, there may be two positioning antennas. Location information may be obtained through calculation with reference to data collected by the two positioning antennas. Defining the spacing between the two positioning antennas as being greater than 30 cm may satisfy a calculation requirement of the positioning antenna and help improve positioning accuracy.

In some exemplary embodiments, the unmanned aerial vehicle may further include a conducting wire electrically connected to the positioning antenna, the arm may be a hollow-tubular structure, and the conducting wire may be electrically connected to a control circuit of the central body via the arm after the conducting wire passes through the motor mounting base.

In some exemplary embodiments, the positioning antenna may be electrically connected to the control circuit of the central body by the conducting wire. This may ensure stability and reliability of data exchange between the positioning antenna and the control circuit during the flight. The conducting wire may pass through the motor mounting base and the hollow-tubular arm and extend to the control circuit of the central body, so that the motor mounting base, the arm, and the central body may wrap the conducting wire. This, on one hand, may further improve protection for the conducting wire, and on the other hand, may make an exterior of the unmanned aerial vehicle simple.

In some exemplary embodiments, an axis of rotation of the motor may be disposed obliquely to a yaw axis of the unmanned aerial vehicle, and the positioning antenna may be disposed obliquely to or in parallel with the yaw axis of the unmanned aerial vehicle.

In some exemplary embodiments, the axis of rotation of the motor may be defined as being disposed obliquely to the yaw axis of the unmanned aerial vehicle, so that a tilt of the propeller may also be generated. This may help a propeller disk of the propeller avoids another structure, and ensure safe operation of the unmanned aerial vehicle. The positioning antenna may need to be disposed upward in arrangement. Because the positioning antenna located on the top of the motor mounting base is disposed obliquely to or in parallel with the yaw axis, it may be ensured that an arrangement requirement of the positioning antenna is satisfied, and accurate positioning is ensured.

In some exemplary embodiments, the positioning antenna may be disposed vertically to the top of the motor mounting base.

In some exemplary embodiments, the positioning antenna may be defined as being disposed vertically to the top of the motor mounting base. This may ensure equal signal strength of the positioning antenna in a circumferential direction of the motor mounting base.

In some exemplary embodiments, the positioning antenna may be disposed obliquely to the top of the motor mounting base.

In some exemplary embodiments, the positioning antenna may be defined as being disposed obliquely to the top of the motor mounting base. The positioning antenna may be away from other structures of the unmanned aerial vehicle based on a requirement, so that the positioning antenna may be less blocked.

In some exemplary embodiments, the arm may be rotatably connected or fixedly connected to the central body.

In some exemplary embodiments, when the arm is rotatably connected to the central body, the arm may be rotated based on a requirement of the antenna, to adjust an antenna angle at any time and ensure that the antenna is not blocked. When the arm is fixedly connected to the central body, stability and reliability of the connection may be fully ensured.

According to another aspect of this disclosure, an unmanned aerial vehicle may be provided and may include a central body, an arm, a motor, a propeller, and an antenna, where the arm may be connected to the central body; the motor may be connected to an end of the arm away from the central body; the propeller may be connected to the motor, and the motor may be configured to drive the propeller to rotate, to provide power for flying; and the antenna may be connected to the end of the arm away from the central body, and disposed opposite to the motor, where the antenna may be located in a position above the motor, and the propeller may be located in a position below the motor.

In the unmanned aerial vehicle provided by exemplary embodiments of this disclosure, the propeller may be disposed in a position below the corresponding motor, that is, the motor may be inverted, open space above the motor may be reserved for placing another component such as the antenna, and the antenna may be disposed in a position above the motor and opposite to the motor. This may satisfy an arrangement requirement of the component of the unmanned aerial vehicle, prevent the antenna from being blocked during the flight of the unmanned aerial vehicle, and ensure normal operation of the antenna and improve product reliability. In addition, an arrangement requirement of the antenna of the unmanned aerial vehicle may be satisfied without adding an additional structure such as an antenna support. Therefore, the antenna may be arranged in a highly integrated manner, the weight of the unmanned aerial vehicle may be lighter, flight duration may be longer, and the unmanned aerial vehicle has fewer folding steps and a higher storage speed.

In addition, the unmanned aerial vehicle in the exemplary embodiments provided by this disclosure may further have the following additional technical features.

In some exemplary embodiments, there may be a plurality of arms, the plurality of arms may be distributed along a circumferential direction of the central body, and the quantity of motor(s) may be equal to the quantity of propeller(s).

In some exemplary embodiments, the plurality of arms may be defined as being peripherally disposed relative to the central body, and a motor and a propeller may be disposed on each arm. Therefore, propellers located in different directions may be coordinated and controlled to control flight of the unmanned aerial vehicle conveniently.

In some exemplary embodiments, a spacing between two adjacent motors may be greater than a diameter of a propeller disk of any one of the propellers.

In some exemplary embodiments, the spacing between two adjacent motors may be a spacing between rotation centers of two corresponding adjacent propellers. The spacing may be defined as being greater than the diameter of the propeller disk of any one of the propellers. This may ensure that two adjacent propellers do not mutually collide in a rotation process, reserve sufficient rotation space for each other, and ensure reliable operation of the unmanned aerial vehicle. For example, each propeller of a same unmanned aerial vehicle usually may have a same diameter of propeller disk, and when there is a difference, a largest diameter of the propeller disk may prevail preferentially. In some exemplary embodiments, a spacing between two adjacent motors may be defined as being greater than a sum of radii of propeller disks of two corresponding propellers.

In some exemplary embodiments, a preset spacing exists between propeller disks of the propellers.

In some exemplary embodiments, a relationship between the spacing between two adjacent motors and a size of the propeller disk may not be defined, but the existing preset spacing between the propeller disks of the propellers may be directly defined. Regardless of whether diameters of the propeller disks of the propellers are the same, positions of the propellers may be correspondingly adjusted, to ensure that the preset spacing exists between the propeller disks. This may ensure that the propellers do not mutually collide in a rotation process, reserve sufficient rotation space for each other, and ensure reliable operation of the unmanned aerial vehicle.

In some exemplary embodiments, the propeller disks of the propellers avoid the central body, the arm, and the motor.

In some exemplary embodiments, the propeller disk formed by rotation of the propeller may be a virtual structure, and represents a rotation space of the propeller. By further defining the propeller disk that avoids the central body, the arm, and the motor, it may be ensured that the propeller does not interfere with a nearby structure when the propeller is located on a top of the motor. This may avoid a collision and ensures reliable operation of the unmanned aerial vehicle. In some exemplary embodiments, a shape of the arm may be optimized so that the arm avoids the propeller disk. For example, the arm may be disposed in a bending shape that protrudes upward. In some exemplary embodiments, the arm may be oblique downward; or an included angle between an axis of rotation of the propeller and the arm may be adjusted; or the arm may be prolonged so that the propeller disk avoids the central body.

In some exemplary embodiments, the antenna may be located above the motor.

In some exemplary embodiments, the antenna may be further defined as being disposed above the motor, that is, the motor may provide a mounting position for the antenna. This may ensure reliable mounting of the antenna.

In some exemplary embodiments, the antenna may include a positioning antenna and a communication antenna.

In some exemplary embodiments, it may be defined that the antenna disposed on the top of the motor includes a positioning antenna and a communication antenna respectively configured to determine a location of the unmanned aerial vehicle and transmit data between the unmanned aerial vehicle and a ground control terminal. The positioning antenna and the communication antenna may have a high requirement for non-blocking. Disposing the positioning antenna and the communication antenna on the top of the motor may ensure normal operation of the positioning antenna and the communication antenna and improve product reliability. In addition, no additional antenna support needs to be disposed for the unmanned aerial vehicle. Therefore, the weight of the unmanned aerial vehicle may be lighter, flight duration may be longer, and the unmanned aerial vehicle has fewer folding steps and a higher storage speed.

In some exemplary embodiments, there may be at least four arms; and the antenna may include two positioning antennas and two communication antennas, and one of the positioning antennas or one of the communication antennas may be disposed above the motor.

In some exemplary embodiments, it may be further defined that the antenna includes two positioning antennas and two communication antennas. Correspondingly, there may be at least four arms. In this case, each antenna may be independently disposed on one motor. This may avoid mutual impact caused by an excessively short spacing between antennas and ensures product reliability.

In some exemplary embodiments, the positioning antennas may be real-time differential positioning antennas, and a spacing between central points of the two real-time differential positioning antennas may be greater than or equal to 30 cm.

In some exemplary embodiments, the positioning antennas may be defined as real-time differential positioning antennas. Centimeter-level positioning accuracy may be obtained outdoors in real time. This may satisfy a high-accuracy positioning requirement and expand an application scope of the unmanned aerial vehicle. The real-time differential positioning antenna may have a high arrangement requirement. A connection line between the central points of the two real-time differential positioning antennas may be a baseline. The baseline may be required to be at least 30 cm, that is, the spacing between the central points of the two real-time differential positioning antennas may need to be at least 30 cm. Correspondingly, a spacing between central points of motors to which the two real-time differential positioning antennas may be connected may be greater than or equal to 30 cm. In addition, the real-time differential positioning antenna may further need to be disposed upward, and a radiation angle of the real-time differential positioning antenna in a horizontal plane may need to reach 150°. Connecting the real-time differential positioning antenna to the top of the motor may satisfy the foregoing arrangement requirement and ensure normal operation of the real-time differential positioning antenna.

In some exemplary embodiments, the unmanned aerial vehicle may further include a photographing apparatus connected to a bottom of the central body, where a lens of the photographing apparatus may face toward a front direction, and the two communication antennas may be located in front of the central body.

In some exemplary embodiments, arrangement positions of the communication antennas may need to ensure integrity of directivity diagrams of the communication antennas, that is, no other blocking structure may exist within coverage of the directivity diagrams. Because the lens of the photographing apparatus of the unmanned aerial vehicle faces toward the front direction, and the communication antennas may be disposed in front of the central body and correspond to the two front arms, integrity of the directivity diagrams of the communication antennas may be ensured, and smooth communication with the ground control terminal may be maintained. For example, there may be four arms, the communication antennas may be located in positions above the motors of the two front arms, and the positioning antennas may be located in positions above the motors of the two rear arms. Further, the bottom of the central body may be further connected to a foot support for supporting. In the related art, communication antennas may be disposed in positions below motors of two front arms. The communication antennas may be not blocked when an unmanned aerial vehicle flies forward (that is, the unmanned aerial vehicle flies toward the ground control terminal with its front facing toward a ground control terminal), but the communication antennas may be blocked when the unmanned aerial vehicle flies backward (that is, the unmanned aerial vehicle flies in a direction away from the ground control terminal with its front facing away from the ground control terminal).

In some exemplary embodiments, the communication antennas may be software-defined radio antennas.

In some exemplary embodiments, the communication antennas may be defined as software-defined radio antennas (Software Definition Radio, SDR antenna), and may be upgraded by downloading and updating software, without completely replacing hardware. This may help reduce subsequent product maintenance costs. The communication antennas may be used for multi-mode, multi-frequency, and multi-function wireless communication, featuring a wide application scope. Therefore, product adaptability may be improved. In some exemplary embodiments, the communication antennas use 2T2R (T represents transmit, and R represents receive) antennas.

The additional aspects and advantages of this disclosure become more apparent in the following description, or are learned through practice of this disclosure.

### BRIEF DESCRIPTION OF THE DRAWINGS

The foregoing and/or additional aspects and advantages of this disclosure will become more apparent and comprehensible in the description of the embodiments in combination with the accompanying drawings.

FIG. 1 is a schematic structural diagram of an unmanned aerial vehicle according to exemplary embodiments of this disclosure;

FIG. 2 is a main view of an unmanned aerial vehicle according to exemplary embodiments of this disclosure; and

FIG. 3 is a bottom view of an unmanned aerial vehicle according to exemplary embodiments of this disclosure.

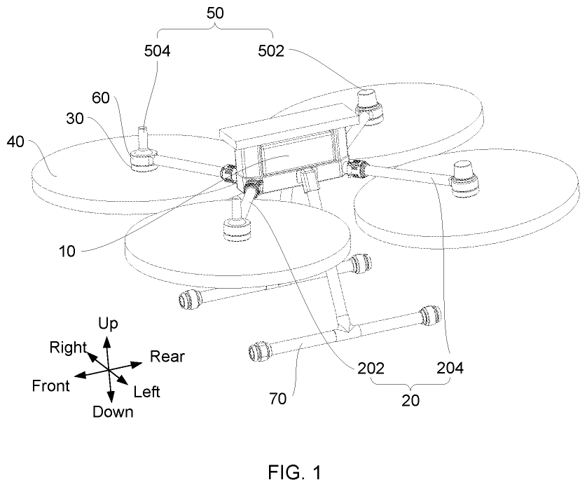

A correspondence between reference numerals and names of components in FIG. 1 to FIG. 3 is as follows:

10: central body; 20: arm; 202: front arm; 204: rear arm; 30: motor; 40: propeller disk; 50: antenna; 502: real-time differential positioning antenna; 504: software-defined radio antenna; 60: motor mounting base; and 70: foot support.

### DETAILED DESCRIPTION OF THE DRAWINGS

The following clearly describes the technical solutions in the embodiments of the present disclosure with reference to the accompanying drawings in the embodiments of the present disclosure. The described embodiments are merely some but not all of the embodiments of the present disclosure. All other embodiments obtained by persons of ordinary skill in the art based on the embodiments of the present disclosure without creative efforts shall fall within the protection scope of the present disclosure.

It should be noted that, when a component is described as “fixed” to another component, the component may be directly located on another component, or an intermediate component may exist therebetween. When a component is considered as “connected” to another component, the component may be directly connected to another element, or an intermediate element may exist therebetween.

Unless otherwise defined, meanings of all technical and scientific terms used in this specification are the same as those generally understood by persons skilled in the art of the present disclosure. The terms used in this specification of the present disclosure herein are used only to describe specific embodiments, and not intended to limit the present disclosure. The term “and/or” used in this specification includes any or all possible combinations of one or more associated listed items.

The following describes in detail some implementations of the present disclosure with reference to the accompanying drawings. Under a condition that no conflict occurs, the following embodiments and features in the embodiments may be mutually combined.

The terminology used herein is for the purpose of describing particular exemplary embodiments only and is not intended to be limiting. When used in this disclosure, the terms “comprise”, “comprising”, “include” and/or “including” refer to the presence of stated features, integers, steps, operations, elements, and/or components, but do not preclude the presence or addition of one or more other features, integers, steps, operations, elements, components, and/or groups thereof. As used in this disclosure, the term “A on B” means that A is directly adjacent to B (from above or below), and may also mean that A is indirectly adjacent to B (i.e., there is some element between A and B); the term “A in B” means that A is all in B, or it may also mean that A is partially in B.

In view of the following description, these and other features of the present disclosure, as well as operations and functions of related elements of the structure, and the economic efficiency of the combination and manufacture of the components, may be significantly improved. All of these form part of the present disclosure with reference to the drawings. However, it should be clearly understood that the drawings are only for the purpose of illustration and description, and are not intended to limit the scope of the present disclosure. It is also understood that the drawings are not drawn to scale.

In some exemplary embodiments, numbers expressing quantities or properties used to describe or define the embodiments of the present disclosure should be understood as being modified by the terms “about”, “generally”, “approximate,” or “substantially” in some instances. For example, “about”, “generally”, “approximately” or “substantially” may mean a ±20% change in the described value unless otherwise stated. Accordingly, in some exemplary embodiments, the numerical parameters set forth in the written description and the appended claims are approximations, which may vary depending upon the desired properties sought to be obtained in a particular embodiment. In some exemplary embodiments, numerical parameters should be interpreted in accordance with the value of the parameters and by applying ordinary rounding techniques. Although a number of embodiments of the present disclosure provide a broad range of numerical ranges and parameters that are approximations, the values in the specific examples are as accurate as possible.

Each of the patents, patent applications, patent application publications, and other materials, such as articles, books, instructions, publications, documents, products, etc., cited herein are hereby incorporated by reference, which are applicable to all contents used for all purposes, except for any history of prosecution documents associated therewith, or any identical prosecution document history, which may be inconsistent or conflicting with this document, or any such subject matter that may have a restrictive effect on the broadest scope of the claims associated with this document now or later. For example, if there is any inconsistent or conflicting in descriptions, definitions, and/or use of a term associated with this document and descriptions, definitions, and/or use of the term associated with any materials, the term in this document shall prevail.

It should be understood that the embodiments of the application disclosed herein are merely described to illustrate the principles of the embodiments of the application. Other modified embodiments are also within the scope of this disclosure. Therefore, the embodiments disclosed herein are by way of example only and not limitations. Those skilled in the art may adopt alternative configurations to implement the technical solution in this disclosure in accordance with the embodiments of the present disclosure. Therefore, the embodiments of the present disclosure are not limited to those embodiments that have been precisely described in this disclosure.

The technical solutions in the embodiments of the present disclosure are clearly and completely described below with reference to the accompanying drawings in the embodiments of the present disclosure. The described embodiments are merely some rather than all of the embodiments of the present disclosure. All other embodiments obtained by a person of ordinary skill in the art based on the embodiments of the present disclosure without creative efforts fall within the protection scope of the present disclosure.

To make the objective, features, and advantages of this disclosure more comprehensible, the following further describes this disclosure in detail with reference to accompanying drawings and specific embodiments. It should be noted that under a condition that no conflict occurs, the embodiments of this disclosure and features in the embodiments may be mutually combined.

A plurality of specific details is described in the following description for fully understanding this disclosure. However, this disclosure may be further implemented in other manners different from this described herein. Therefore, the protection scope of this disclosure is not limited by the following disclosed specific embodiments.

The following describes the unmanned aerial vehicle according to some exemplary embodiments of this disclosure with reference to FIG. 1 to FIG. 3.

As shown in FIG. 1, exemplary embodiments of an aspect of this disclosure may provide an unmanned aerial vehicle, including a central body 10, a plurality of arms 20, a plurality of motors 30, a plurality of propellers (a propeller disk 40 shown in FIG. 1 may be a virtual disk-like structure formed by rotation of a propeller), and a plurality of antennas 50. The plurality of arms 20 may be connected to the central body 10, a motor mounting base 60 may be disposed at one end of each arm 20 away from the central body 10, and the motor mounting base 60 may include a top and a bottom that is opposite to the top. The plurality of motors 30 may be mounted on the motor mounting bases 60 of the plurality of arms 20, respectively. The plurality of propellers may be connected to the plurality of motors 30, respectively, and the motors 30 may be configured to drive the propellers to rotate, to provide power for the unmanned aerial vehicle to fly. The plurality of antennas 50 may be disposed on the motor mounting bases 60 of at least two arms 20 in the plurality of arms 20, respectively, the antenna 50 being located on the top of the motor mounting base 60, where the propeller may be located in a position below the motor mounting base 60, and the antenna 50 may be located in a position above the motor mounting base 60.

In the unmanned aerial vehicle provided by exemplary embodiments of this disclosure, the motor mounting base 60 may be disposed at one end of the arm 20 away from the central body 10. The motor mounting base 60, on one hand, may be configured to mount the motor 30 for driving the propeller, and on the other hand, may provide a stable mounting position for the antenna 50. For example, the antenna 50 may be mounted on the top of the motor mounting base 60 and may be located in a position above the motor mounting base 60, and the propeller may be located in a position below the motor mounting base 60. This may ensure open space for mounting the antennas 50 without adding an additional structure, make the antenna 50 less blocked by a structure such as a propeller, and reduce the weight of the unmanned aerial vehicle, so that the unmanned aerial vehicle has longer flight duration, fewer folding steps, and a higher storage speed. For example, the motor 30 may be mounted on the motor mounting base 60, and its specific mounting position is not limited. For example, the motor 30 may be located at one end of the motor mounting base 60 that is farthest away from the central body 10. The propeller may be connected to the motor 30, as long as it is ensured that the propeller is located in a position below the motor mounting base 60.

In some exemplary embodiments, the antenna 50 may include at least one of the following: a communication antenna, a positioning antenna, and a ranging antenna.

In some exemplary embodiments, the antenna 50 may include at least one of a communication antenna, a positioning antenna, and a ranging antenna. The communication antenna may be configured to exchange data with the outside, the positioning antenna may be configured to obtain location information of the unmanned aerial vehicle, and the ranging antenna may be configured to detect a distance between the unmanned aerial vehicle and a nearby obstacle. Making the antenna 50 less blocked may ensure normal operation of the antenna 50 and facilitate reliable flight of the unmanned aerial vehicle.

In some exemplary embodiments, the antenna 50 may include a communication antenna.

In some exemplary embodiments, the antenna 50 may include a communication antenna for exchanging data with the outside. Because the communication antenna is located in a position above the motor mounting base 60, normal operation of the communication antenna may be ensured, and product reliability may be improved. In addition, an arrangement requirement of the communication antenna of the unmanned aerial vehicle may be satisfied without adding an additional structure. Therefore, the communication antenna may be arranged in a highly integrated manner, and a fuselage weight may be also reduced, so that flight duration of the unmanned aerial vehicle may be longer and that the unmanned aerial vehicle has fewer folding steps and a higher storage speed. For example, the communication antenna may be a software-defined radio antenna 504, and may be upgraded by downloading and updating software, without completely replacing hardware. This may help reduce subsequent product maintenance costs. The communication antenna may be used for multi-mode, multi-frequency, and multi-function wireless communication, featuring a wide application scope. Therefore, product adaptability may be improved. In some exemplary embodiments, the communication antenna uses a 2T2R antenna.

As shown in FIG. 1, in some exemplary embodiments, the plurality of arms 20 may include a front arm 202, and the communication antenna may be disposed on a motor mounting base 60 of the front arm 202.

In some exemplary embodiments, an arrangement position of the communication antenna may need to ensure integrity of a directivity diagram of the communication antenna, that is, no other blocking structure may exist within coverage of the directivity diagram. Because the communication antenna is disposed on the motor mounting base 60 of the front arm 202, integrity of the directivity diagram of the communication antenna may be ensured, and smooth communication may be maintained.

As shown in FIG. 1, in some exemplary embodiments, there may be a plurality of communication antennas, and the plurality of communication antennas may be located on two sides of a roll axis of the unmanned aerial vehicle, respectively.

In some exemplary embodiments, there may be a plurality of communication antennas, and this may help improve communication capability of the unmanned aerial vehicle. The roll axis may be an axis of rotation when the unmanned aerial vehicle rolls left and right (that is, an axis that extends along front and rear directions of the unmanned aerial vehicle). The plurality of communication antennas may be located on the two sides of the roll axis of the unmanned aerial vehicle, respectively. This may ensure basically equal strength of communication signals in left and right directions of the unmanned aerial vehicle and ensure normal communication of the unmanned aerial vehicle.

As shown in FIG. 1, in some exemplary embodiments, the plurality of communication antennas may be symmetrically disposed relative to the roll axis of the unmanned aerial vehicle.

In some exemplary embodiments, the plurality of communication antennas may be further defined as being symmetrically disposed relative to the roll axis of the unmanned aerial vehicle. This may not only enhance equal strength of communication signals in the left and right directions of the unmanned aerial vehicle, but also enable even weight distribution of the unmanned aerial vehicle and help ensure flight attitude balance of the unmanned aerial vehicle.

In some exemplary embodiments, as shown in FIG. 1, the plurality of arms 20 may include a front arm 202 and a rear arm 204 that is opposite to the front arm 202, a part of the communication antennas may be disposed on a motor mounting base 60 of the front arm 202, and another part of the communication antennas may be disposed on a motor mounting base 60 of the rear arm 204.

In some exemplary embodiments, disposing all the communication antennas separately on the front arm 202 and the rear arm 204 may expand signal coverage of the communication antennas, ensure that complete directivity diagrams may be obtained in both front and rear directions of the communication antennas, and help enhance communication reliability of the unmanned aerial vehicle.

In some exemplary embodiments, there may be a plurality of communication antennas, and the plurality of communication antennas may be located on two sides of a pitch axis of the unmanned aerial vehicle, respectively.

In some exemplary embodiments, there may be a plurality of communication antennas, and this may help improve communication capability of the unmanned aerial vehicle. The pitch axis may be an axis of rotation when the unmanned aerial vehicle raises or lowers its head (that is, an axis that extends along left and right directions of the unmanned aerial vehicle). The plurality of communication antennas may be located on the two sides of the pitch axis of the unmanned aerial vehicle, respectively. This may ensure basically equal strength of communication signals in front and rear directions of the unmanned aerial vehicle and ensure normal communication of the unmanned aerial vehicle.

In some exemplary embodiments, the plurality of communication antennas may be symmetrically disposed relative to the pitch axis of the unmanned aerial vehicle.

In some exemplary embodiments, the plurality of communication antennas may be further defined as being symmetrically disposed relative to the pitch axis of the unmanned aerial vehicle. This may not only enhance equal strength of communication signals in the front and rear directions of the unmanned aerial vehicle, but also enable even weight distribution of the unmanned aerial vehicle and help ensure flight attitude balance of the unmanned aerial vehicle.

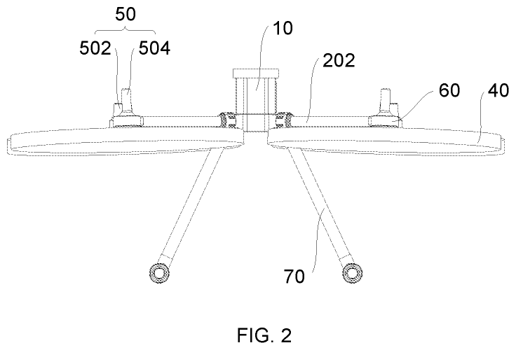

As shown in FIG. 1 and FIG. 2, in some exemplary embodiments, there may be a plurality of communication antennas, and the plurality of communication antennas may be at a same level relative to the central body 10.

In some exemplary embodiments, there may be a plurality of communication antennas, and this may help improve communication capability of the unmanned aerial vehicle. Because the plurality of communication antennas is at the same level relative to the central body 10, a structure of the unmanned aerial vehicle may be more compact, and this may help reduce the possibility of the communication antennas being damaged by an external force.

In some exemplary embodiments, there may be a plurality of communication antennas, and the plurality of communication antennas may be symmetrically disposed relative to the central body 10.

In some exemplary embodiments, there may be a plurality of communication antennas, and this may help improve communication capability of the unmanned aerial vehicle. The plurality of communication antennas may be symmetrically disposed relative to the central body 10. This may not only enhance equal strength of communication signals of the unmanned aerial vehicle in a circumferential direction of the central body 10, but also enable even weight distribution of the unmanned aerial vehicle and help ensure flight attitude balance of the unmanned aerial vehicle.

In some exemplary embodiments, the unmanned aerial vehicle may further include a conducting wire electrically connected to the communication antenna, the arm 20 may be a hollow-tubular structure, and the conducting wire may be electrically connected to a control circuit of the central body 10 via the arm 20 after the conducting wire passes through the motor mounting base 60.

In some exemplary embodiments, the communication antenna may be electrically connected to the control circuit of the central body 10 by the conducting wire. This may ensure stability and reliability of data exchange between the communication antenna and the control circuit during the flight. The conducting wire may pass through the motor mounting base 60 and the hollow-tubular arm 20 and extend to the control circuit of the central body 10, so that the motor mounting base 60, the arm 20, and the central body 10 may wrap the conducting wire. This, on one hand, may further improve protection for the conducting wire, and on the other hand, may make an exterior of the unmanned aerial vehicle simple.

In some exemplary embodiments, the communication antenna may be a line-of-sight communication antenna.

In some exemplary embodiments, the communication antenna may be a line-of-sight communication antenna. A radio signal may need to be propagated in a straight line between a transmitting end and a receiving end without being blocked, and a radio frequency thereof may be between 10 GHz and 66 GHz. Because the line-of-sight communication antenna is disposed in open space above the motor mounting base 60, signal blocking may be reduced for the communication antenna, and normal operation of the communication antenna may be ensured.

In some exemplary embodiments, the communication antenna may be a Wi-Fi (Wireless Fidelity, wireless local area network) antenna.

In some exemplary embodiments, the communication antenna may be further defined as a Wi-Fi antenna. This may enhance signal strength of the wireless network and improve reliability of communication.

In some exemplary embodiments, the communication antenna may be configured to receive a control signal sent by a ground control terminal, and send, to the ground control terminal, sensing data of a sensor carried by the unmanned aerial vehicle.

In some exemplary embodiments, the communication antenna may be configured to exchange data with the ground control terminal. On one hand, the communication antenna may receive the control signal to control operation of the unmanned aerial vehicle based on the control signal. On the other hand, the communication antenna may send the sensing data of the sensor. When the sensing data is an operation parameter of the unmanned aerial vehicle, the ground control terminal may conveniently know an operation status of the unmanned aerial vehicle in time, and further perform a corresponding control operation. This may ensure reliable control by the ground control terminal over the unmanned aerial vehicle and improve safety of operation.

In some exemplary embodiments, the sensor may be an image sensor, and the sensing data may be image information.

In some exemplary embodiments, the sensor may be an image sensor, and the sensing data may be image information. In other words, a user may configure an image sensor on the unmanned aerial vehicle, and collect specific image information by virtue of a flight capability of the unmanned aerial vehicle, and the image information may be transmitted back to the ground control terminal via the communication antenna. Therefore, an image collection range may be expanded.

In some exemplary embodiments, the communication antenna may be disposed obliquely to or in parallel with a yaw axis of the unmanned aerial vehicle.

In some exemplary embodiments, the yaw axis may be an axis of rotation when the unmanned aerial vehicle adjusts a course (that is, an axis that extends along up and down directions of the unmanned aerial vehicle). Disposing the communication antenna obliquely to or in parallel with the yaw axis may ensure that the communication antenna has a trend of extending to an upper open space, and this may help ensure integrity of a directivity diagram of the communication antenna.

In some exemplary embodiments, the communication antenna may be disposed vertically to the top of the motor mounting base 60.

In some exemplary embodiments, the communication antenna may be defined as being disposed vertically to the top of the motor mounting base 60. This may ensure equal strength of communication of the communication antenna in a circumferential direction of the motor mounting base 60.

In some exemplary embodiments, the communication antenna may be disposed obliquely to the top of the motor mounting base 60.

In some exemplary embodiments, the communication antenna may be defined as being disposed obliquely to the top of the motor mounting base 60. The communication antenna may be away from other structures of the unmanned aerial vehicle based on a requirement, so that the communication antenna may be less blocked.

In some exemplary embodiments, the antenna may include a positioning antenna.

In some exemplary embodiments, the antenna may include a positioning antenna for obtaining location information of the unmanned aerial vehicle. Because the positioning antenna is located in a position above the motor mounting base 60, normal operation of the positioning antenna may be ensured, and product reliability may be improved. In addition, an arrangement requirement of the positioning antenna of the unmanned aerial vehicle may be satisfied without adding an additional structure. Therefore, the positioning antenna may be arranged in a highly integrated manner, and a fuselage weight may be also reduced, so that flight duration of the unmanned aerial vehicle may be longer and that the unmanned aerial vehicle has fewer folding steps and a higher storage speed. For example, the positioning antenna may be a real-time differential positioning antenna 502. Centimeter-level positioning accuracy may be obtained outdoors in real time. This may satisfy a high-accuracy positioning requirement and expand an application scope of the unmanned aerial vehicle.

In some exemplary embodiments, the plurality of arms 20 may include a front arm 202, and the positioning antenna may be disposed on a motor mounting base 60 of the front arm 202.

In some exemplary embodiments, arranging the positioning antenna on the motor mounting base 60 of the front arm 202 may make the positioning antenna less blocked by a front structure and ensure accurate positioning.

As shown in FIG. 1, in some exemplary embodiments, the plurality of arms 20 may include a rear arm 204, and the positioning antenna may be disposed on a motor mounting base 60 of the rear arm 204.

In some exemplary embodiments, arranging the positioning antenna on the motor mounting base 60 of the rear arm 204 may make the positioning antenna less blocked by a rear structure, ensure accurate positioning, and further reserve a front arm 202 for another structure requiring front open space, such as a communication antenna.

As shown in FIG. 1, in some exemplary embodiments, there may be a plurality of positioning antennas, and the plurality of positioning antennas may be located on two sides of a roll axis of the unmanned aerial vehicle, respectively.

In some exemplary embodiments, there may be a plurality of positioning antennas, and the plurality of positioning antennas may be located on the two sides of the roll axis of the unmanned aerial vehicle, respectively. This may increase spacings between the plurality of positioning antennas, increase radiation angles of the positioning antennas in a horizontal plane, and help improve positioning accuracy of the unmanned aerial vehicle.

As shown in FIG. 1, in some exemplary embodiments, the plurality of positioning antennas may be symmetrically disposed relative to the roll axis of the unmanned aerial vehicle.

In some exemplary embodiments, the plurality of positioning antennas may be further defined as being symmetrically disposed relative to the roll axis of the unmanned aerial vehicle. This may not only enhance positioning accuracy of the unmanned aerial vehicle, but also enable even weight distribution of the unmanned aerial vehicle and help ensure flight attitude balance of the unmanned aerial vehicle.

In some exemplary embodiments, the plurality of arms 20 may include a front arm 202 and a rear arm 204 that is opposite to the front arm 202, a part of the positioning antennas may be disposed on a motor mounting base 60 of the front arm 202, and another part of the positioning antennas may be disposed on a motor mounting base 60 of the rear arm 204.

In some exemplary embodiments, disposing all the positioning antennas separately on the front arm 202 and the rear arm 204 may make the positioning antennas less blocked by nearby front and rear structures and ensure accurate positioning.

In some exemplary embodiments, there may be a plurality of positioning antennas, and the plurality of positioning antennas may be located on two sides of a pitch axis of the unmanned aerial vehicle, respectively.

In some exemplary embodiments, there may be a plurality of positioning antennas, and the plurality of positioning antennas may be located on the two sides of the pitch axis of the unmanned aerial vehicle, respectively. This may increase spacings between the plurality of positioning antennas, increase radiation angles of the positioning antennas in a horizontal plane, and help improve positioning accuracy of the unmanned aerial vehicle.

In some exemplary embodiments, the plurality of positioning antennas may be symmetrically disposed relative to the pitch axis of the unmanned aerial vehicle.

In some exemplary embodiments, the plurality of positioning antennas may be further defined as being symmetrically disposed relative to the pitch axis of the unmanned aerial vehicle. This may not only enhance positioning accuracy of the unmanned aerial vehicle, but also enable even weight distribution of the unmanned aerial vehicle and help ensure flight attitude balance of the unmanned aerial vehicle.

As shown in FIG. 1 and FIG. 2, in some exemplary embodiments, there may be a plurality of positioning antennas, and the plurality of positioning antennas may be at a same level relative to the central body 10.

In some exemplary embodiments, there may be a plurality of positioning antennas, and this may help enhance positioning accuracy of the unmanned aerial vehicle. Because the plurality of positioning antennas are at the same level relative to the central body 10, a structure of the unmanned aerial vehicle may be more compact, and this may help reduce the possibility of the positioning antennas being damaged by an external force.

In some exemplary embodiments, there may be a plurality of positioning antennas, and the plurality of positioning antennas may be symmetrically disposed relative to the central body 10.

In some exemplary embodiments, there may be a plurality of communication antennas, and the plurality of communication antennas may be symmetrically disposed relative to the central body 10. This may not only help enhance positioning accuracy of the unmanned aerial vehicle, but also enable even weight distribution of the unmanned aerial vehicle and help ensure flight attitude balance of the unmanned aerial vehicle.

In some exemplary embodiments, the positioning antenna may be configured to receive a positioning signal from a satellite.

In some exemplary embodiments, the positioning antenna not directly used for positioning, but used for receiving a positioning signal from a satellite may be defined. This may reduce the amount of calculation and consumption of calculation time and help prolong flight duration.

In some exemplary embodiments, there may be two positioning antennas, and a spacing between the two positioning antennas may be greater than 30 cm.

In some exemplary embodiments, there may be two positioning antennas. Location information may be obtained through calculation with reference to data collected by the two positioning antennas. Defining the spacing between the two positioning antennas as being greater than 30 cm may satisfy a calculation requirement of the positioning antenna and help improve positioning accuracy.

In some exemplary embodiments, the unmanned aerial vehicle may further include a conducting wire electrically connected to the positioning antenna, the arm 20 may be a hollow-tubular structure, and the conducting wire may be electrically connected to a control circuit of the central body 10 via the arm 20 after the conducting wire passes through the motor mounting base 60.

In some exemplary embodiments, the positioning antenna may be electrically connected to the control circuit of the central body 10 by the conducting wire. This may ensure stability and reliability of data exchange between the positioning antenna and the control circuit during the flight. The conducting wire may pass through the motor mounting base 60 and the hollow-tubular arm 20 and extend to the control circuit of the central body 10, so that the motor mounting base 60, the arm 20, and the central body 10 may wrap the conducting wire. This, on one hand, may further improve protection for the conducting wire, and on the other hand, may make an exterior of the unmanned aerial vehicle simple.

As shown in FIG. 2, in some exemplary embodiments, an axis of rotation of the motor 30 may be disposed obliquely to a yaw axis of the unmanned aerial vehicle.

In some exemplary embodiments, the axis of rotation of the motor 30 may be defined as being disposed obliquely to the yaw axis of the unmanned aerial vehicle, so that a tilt of the propeller may also be generated. This may help the propeller disk 40 of the propeller avoid another structure, and ensures safe operation of the unmanned aerial vehicle.

In some exemplary embodiments, the positioning antenna may be disposed obliquely to or in parallel with the yaw axis of the unmanned aerial vehicle.

In some exemplary embodiments, the positioning antenna may need to be disposed upward in arrangement. Because the positioning antenna located on the top of the motor mounting base 60 is disposed obliquely to or in parallel with the yaw axis, it may be ensured that an arrangement requirement of the positioning antenna is satisfied, and accurate positioning is ensured.

In some exemplary embodiments, the positioning antenna may be disposed vertically to the top of the motor mounting base 60.

In some exemplary embodiments, the positioning antenna may be defined as being disposed vertically to the top of the motor mounting base 60. This may ensure equal signal strength of the positioning antenna in a circumferential direction of the motor mounting base 60.

In some exemplary embodiments, the positioning antenna may be disposed obliquely to the top of the motor mounting base 60.

In some exemplary embodiments, the positioning antenna may be defined as being disposed obliquely to the top of the motor mounting base 60. The positioning antenna may be away from other structures of the unmanned aerial vehicle based on a requirement, so that the positioning antenna may be less blocked.

In some exemplary embodiments, the arm 20 may be rotatably connected or fixedly connected to the central body 10.

In some exemplary embodiments, when the arm 20 is rotatably connected to the central body 10, the arm 20 may be rotated based on a requirement of the antenna, to adjust an antenna angle at any time and ensure that the antenna is not blocked. When the arm 20 is fixedly connected to the central body 10, stability and reliability of the connection may be fully ensured.

As shown in FIG. 1, exemplary embodiments of another aspect of this disclosure may provide an unmanned aerial vehicle, including a central body 10, an arm 20, a motor 30, a propeller (a propeller disk 40 shown in FIG. 1 may be a virtual disk-like structure formed by rotation of the propeller), and an antenna 50. The arm 20 may be connected to the central body 10. The motor 30 may be connected to one end of the arm 20 away from the central body 10. The propeller may be connected to the motor 30, and the motor 30 may be configured to drive the propeller to rotate, to provide power for flying. The antenna 50 may be connected to the end of the arm 20 away from the central body 10, and disposed opposite to the motor 30. The antenna 50 may be located in a position above the motor 30, and the propeller may be located in a position below the motor 30.

In the unmanned aerial vehicle provided by exemplary embodiments of this disclosure, the propeller may be disposed in a position below the corresponding motor 30, that is, the motor 30 may be inverted, open space above the motor 30 may be reserved for placing another component such as the antenna 50, and the antenna 50 may be disposed in a position above the motor 30 and opposite to the motor 30. This satisfies an arrangement requirement of the component of the unmanned aerial vehicle, prevents the antenna 50 from being blocked during the flight of the unmanned aerial vehicle, and may ensure normal operation of the antenna 50 and improve product reliability. In addition, an arrangement requirement of the antenna of the unmanned aerial vehicle may be satisfied without adding an additional structure such as an antenna support. Therefore, the antenna 50 may be arranged in a highly integrated manner, the weight of the unmanned aerial vehicle may be lighter, flight duration may be longer, and the unmanned aerial vehicle has fewer folding steps and a higher storage speed.

As shown in FIG. 1, in some exemplary embodiments, there may be a plurality of arms 20, the plurality of arms 20 may be distributed along a circumferential direction of the central body 10, and the quantity of motors 30 may be equal to the quantity of propellers.

In some exemplary embodiments, the plurality of arms 20 may be defined as being disposed along the circumferential direction of the central body 10, and a motor 30 and a propeller may be disposed on each arm 20. Therefore, propellers located in different directions may be coordinated and controlled to control flight of the unmanned aerial vehicle conveniently.

In some exemplary embodiments, a spacing between two adjacent motors 30 may be greater than a diameter of a propeller disk 40 of any one of the propellers.

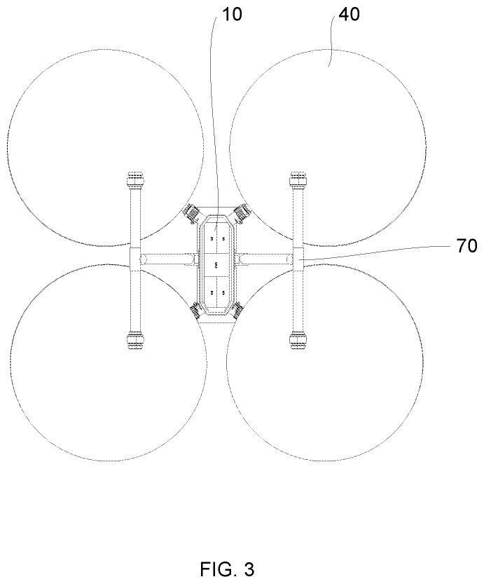

In some exemplary embodiments, the spacing between two adjacent motors 30 may be a spacing between rotation centers of two corresponding adjacent propellers. The spacing may be defined as being greater than the diameter of the propeller disk of any one of the propellers, and as shown in FIG. 3, a spacing exists between two adjacent propeller disks 40. This may ensure that two adjacent propellers do not mutually collide in a rotation process, reserve sufficient rotation space for each other, and ensure reliable operation of the unmanned aerial vehicle. For example, each propeller of a same unmanned aerial vehicle usually may have a same diameter of propeller disk, and when there is a difference, a largest diameter of the propeller disk may prevail preferentially. In some exemplary embodiments, a spacing between two adjacent motors 30 may be defined as being greater than a sum of radii of propeller disks 40 of two corresponding propellers.

As shown in FIG. 3, in some exemplary embodiments, a preset spacing may exist between propeller disks 40 of the propellers.

In some exemplary embodiments, a relationship between the spacing between two adjacent motors 30 and a size of the propeller disk 40 may be not defined, but the existing preset spacing between the propeller disks 40 of the propellers may be directly defined. Regardless of whether diameters of the propeller disks of the propellers are the same, positions of the propellers may be correspondingly adjusted, to ensure that the preset spacing exists between the propeller disks 40. This may ensure that the propellers do not mutually collide in a rotation process, reserve sufficient rotation space for each other, and ensure reliable operation of the unmanned aerial vehicle.

As shown in FIG. 1 and FIG. 2, in some exemplary embodiments, the propeller disks 40 of the propellers may be kept away from the central body 10, the arm 20, and the motor 30.

In some exemplary embodiments, the propeller disk 40 formed by rotation of the propeller may be a virtual structure, and represents rotation space of the propeller. By further defining the propeller disk 40 that avoids the central body 10, the arm 20, and the motor 30, it may be ensured that the propeller does not interfere with a nearby structure when the propeller is located on a top of the motor 30. This may avoid a collision and ensures reliable operation of the unmanned aerial vehicle. In some exemplary embodiments, a shape of the arm 20 may be optimized so that the arm 20 avoids the propeller disk 40. For example, the arm 20 may be disposed in a bending shape that protrudes upward. In some exemplary embodiments, the arm 20 may be oblique downward; or an included angle between an axis of rotation of the propeller and the arm 20 may be adjusted; or the arm 20 may be prolonged so that the propeller disk 40 avoids the central body 10.

In some exemplary embodiments, the antenna 50 may be located above the motor 30.

In some exemplary embodiments, the antenna 50 may be further defined as being disposed above the motor 30, that is, the motor 30 may provide a mounting position for the antenna 50. This ensures reliable mounting of the antenna 50.

As shown in FIG. 1 and FIG. 2, in some exemplary embodiments, the antenna 50 may include a positioning antenna (such as a real-time differential positioning antenna 502) and a communication antenna (such as a software-defined radio antenna 504).

In some exemplary embodiments, it may be defined that the antenna 50 disposed on the top of the motor 30 includes a positioning antenna and a communication antenna configured to determine a location of the unmanned aerial vehicle and transmit data between the unmanned aerial vehicle and a ground control terminal, respectively. The positioning antenna and the communication antenna may have a high requirement for non-blocking. Disposing the positioning antenna and the communication antenna on the top of the motor 30 may ensure normal operation of the positioning antenna and the communication antenna and improve product reliability. In addition, no additional antenna support needs to be disposed for the unmanned aerial vehicle. Therefore, the weight of the unmanned aerial vehicle may be lighter, flight duration may be longer, and the unmanned aerial vehicle has fewer folding steps and a higher storage speed.

As shown in FIG. 1, in some exemplary embodiments, there may be at least four arms 20; and the antenna 50 may include two positioning antennas and two communication antennas, and one positioning antenna or one communication antenna may be disposed above one motor 30.

In some exemplary embodiments, it may be further defined that the antenna 50 includes two positioning antennas and two communication antennas. Correspondingly, there may be at least four arms 20. In this case, each antenna 50 may be independently disposed on one motor 30. This may avoid mutual impact caused by an excessively short spacing between different antennas 50 and ensures product reliability.

In some exemplary embodiments, the positioning antennas may be real-time differential positioning antennas 502, and a spacing between central points of the two real-time differential positioning antennas 502 may be greater than or equal to 30 cm.

In some exemplary embodiments, the positioning antennas may be defined as real-time differential positioning antennas 502. Centimeter-level positioning accuracy may be obtained outdoors in real time. This may satisfy a high-accuracy positioning requirement and expand an application scope of the unmanned aerial vehicle. The real-time differential positioning antenna 502 may have a high arrangement requirement. A connection line between the central points of the two real-time differential positioning antennas 502 may be a baseline. The baseline may be required to be at least 30 cm, that is, the spacing between the central points of the two real-time differential positioning antennas 502 may need to be at least 30 cm. Correspondingly, a spacing between central points of motors 30 to which the two real-time differential positioning antennas 502 may be connected may be greater than or equal to 30 cm. In addition, the real-time differential positioning antenna 502 may further need to be disposed upward, and a radiation angle of the real-time differential positioning antenna 502 in a horizontal plane may need to reach 150°. Connecting the real-time differential positioning antenna 502 to the top of the motor 30 may satisfy the foregoing arrangement requirement and ensure normal operation of the real-time differential positioning antenna 502.

In some exemplary embodiments, the unmanned aerial vehicle may further include a photographing apparatus connected to a bottom of the central body 10, where a lens of the photographing apparatus faces toward a front direction.

In some exemplary embodiments, the unmanned aerial vehicle may be further configured with a photographing apparatus, which may be configured to capture an image during flight. This may expand an application scope of the photographing apparatus. The lens of the photographing apparatus of the unmanned aerial vehicle may face toward the front direction. Two arms 20 in the direction may be front arms 202, and two arms 20 in a rear direction may be rear arms 204.

As shown in FIG. 1, in some exemplary embodiments, the two communication antennas may be located in front of the central body 10.

In some exemplary embodiments, arrangement positions of the communication antennas may need to ensure integrity of directivity diagrams of the communication antennas, that is, no other blocking structure exists within coverage of the directivity diagrams. Because the communication antennas are disposed in front of the central body 10 and correspond to the two front arms 202, integrity of the directivity diagrams of the communication antennas may be ensured, and smooth communication with the ground control terminal may be maintained. For example, as shown in FIG. 1, there may be four arms 20, the communication antennas may be located in positions above the motors 30 of the two front arms 202, and the positioning antennas may be located in positions above the motors 30 of the two rear arms 204. Further, the bottom of the central body 10 may be further connected to a foot support 70 for supporting. In the related art, communication antennas may be disposed in positions below motors of two front arms. The communication antennas may be not blocked when an unmanned aerial vehicle flies forward (that is, its front faces toward a ground control terminal, and the unmanned aerial vehicle flies toward the ground control terminal), but the communication antennas may be blocked when the unmanned aerial vehicle flies backward (that is, its front faces away from the ground control terminal, and the unmanned aerial vehicle flies in a direction away from the ground control terminal).

In some exemplary embodiments, the communication antennas may be software-defined radio antennas 504.

In some exemplary embodiments, the communication antennas may be defined as software-defined radio antennas 504, and may be upgraded by downloading and updating software, without completely replacing hardware. This may help reduce subsequent product maintenance costs. The communication antennas may be used for multi-mode, multi-frequency, and multi-function wireless communication, featuring a wide application scope. Therefore, product adaptability may be improved. In some exemplary embodiments, the communication antennas use 2T2R antennas.

As described above, the motor 30 may be inverted in this disclosure, and may be configured to arrange the antenna 50 or another component, so that integrated arrangement of the antenna 50 may be implemented. This avoids additional structure costs, simplifies folding steps of a fuselage, and reduces storage time.

In this disclosure, the term “plurality” indicates two or more, unless otherwise expressly defined. The terms “mounted”, “connected”, “connection”, “fixed”, and the like should be understood in a broad sense. For example, “connection” may be a fixed connection, a detachable connection, or an integrated connection; and “connected” may be “directly connected” or may be “indirectly connected by using an intermediate medium. A person of ordinary skill in the art may understand specific meanings of these terms in this disclosure based on specific situations.

In the description of this specification, the description of the terms “one embodiment”, “some embodiments”, “specific embodiments”, and the like means that specific features, structures, materials, or characteristics described with reference to the embodiment(s) or examples are included in at least one embodiment or example of this disclosure. In this specification, a schematic representation of the foregoing terms does not necessarily refer to a same embodiment or a same example. In addition, the described specific features, structures, materials, or characteristics may be combined in one or more embodiments or examples in an appropriate manner.

The foregoing descriptions are only preferred embodiments of this disclosure, and not intended to limit this disclosure. For a person skilled in the art, this disclosure may be subject to various changes and variations. Any modifications, equivalent replacements, improvements, and the like made within the spirit and principle of this disclosure shall fall within the protection scope of this disclosure.

What is claimed is:

1. An unmanned aerial vehicle, comprising:
a central body;
a plurality of arms, connected to the central body;
a plurality of motor mounting bases, respectively disposed at ends of the plurality of arms away from the central body;
a plurality of motors, respectively mounted on the plurality of motor mounting bases;
a plurality of propellers, respectively connected to the plurality of motors, wherein the plurality of motors is configured to drive the propellers to rotate; and
a plurality of antennas, respectively disposed on the plurality of motor mounting bases,
wherein the plurality of propellers is located lower than the plurality of antennas.

2. The unmanned aerial vehicle according to claim 1, wherein the plurality of antennas includes at least one of a communication antenna, a positioning antenna, or a ranging antenna.

3. The unmanned aerial vehicle according to claim 2, further comprising a conducting wire electrically connected to the communication antenna or the positioning antenna, wherein
each of the plurality of arms is a hollow-tubular structure, and
the conducting wire is electrically connected to a control circuit of the central body via a corresponding arm after the conducting wire passes through a corresponding motor mounting base of the plurality of motor mounting bases.

4. The unmanned aerial vehicle according to claim 2, wherein the communication antenna is a line-of-sight communication antenna.

5. The unmanned aerial vehicle according to claim 4, wherein the communication antenna is a Wi-Fi antenna.

6. The unmanned aerial vehicle according to claim 2, wherein
the communication antenna is configured to receive a control signal sent by a ground control terminal, and send, to the ground control terminal, sensing data of a sensor carried by the unmanned aerial vehicle, and
the positioning antenna is configured to receive a positioning signal from a satellite.

7. The unmanned aerial vehicle according to claim 6, wherein the sensor is an image sensor, and the sensing data is image information.

8. The unmanned aerial vehicle according to claim 2, wherein the communication antenna or the positioning antenna is disposed obliquely to or in parallel with a yaw axis of the unmanned aerial vehicle.

9. The unmanned aerial vehicle according to claim 2, wherein the communication antenna or the positioning antenna is disposed vertically or obliquely to the top of the corresponding motor mounting base.

10. The unmanned aerial vehicle according to claim 1, wherein the plurality of antennas includes a plurality of communication antennas or a plurality of positioning antennas.

11. The unmanned aerial vehicle according to claim 10, wherein the plurality of arms includes at least one front arm and at least one rear arm that is opposite to the front arm,
a part of the plurality of positioning antennas is disposed on the motor mounting base connected to the at least one front arm, and
another part of the plurality of positioning antennas is disposed on the motor mounting base connected to the at least one rear arm.

12. The unmanned aerial vehicle according to claim 10, wherein the plurality of arms includes at least one front arm and at least one rear arm that is opposite to the front arm,
a part of the plurality of communication antennas is disposed on the motor mounting base connected to the at least one front arm, and
another part of the plurality of positioning antennas is disposed on the motor mounting base connected to the at least one rear arm.

13. The unmanned aerial vehicle according to claim 10, wherein the plurality of communication antennas or the plurality of positioning antennas is respectively located on two sides of a roll axis of the unmanned aerial vehicle and symmetrically disposed relative to the roll axis.

14. The unmanned aerial vehicle according to claim 10, wherein the plurality of communication antennas or the plurality of positioning antennas is respectively located on two sides of a pitch axis of the unmanned aerial vehicle and symmetrically disposed relative to the pitch axis.

15. The unmanned aerial vehicle according to claim 10, wherein the plurality of communication antennas or the plurality of positioning antennas is at a same level relative to the central body.

16. The unmanned aerial vehicle according to claim 15, wherein the plurality of communication antennas or the plurality of positioning antennas is symmetrically disposed relative to the central body.

17. The unmanned aerial vehicle according to claim 10, wherein the plurality of antennas includes two positioning antennas, and a spacing between the two positioning antennas is greater than 30 cm.

18. The unmanned aerial vehicle according to claim 2, wherein the positioning antenna is a real-time differential positioning antenna.

19. The unmanned aerial vehicle according to claim 2, wherein an axis of rotation of each motor is disposed obliquely to a yaw axis of the unmanned aerial vehicle.

20. The unmanned aerial vehicle according to claim 1, wherein each of the plurality of arms is rotatably connected or fixedly connected to the central body.
